(19) United States
(12) Patent Application Publication
(10) Pub. No.: US 2003/0233458 A1
(43) Pub. Date: Dec. 18, 2003

(54) System and method for providing service in wireless network environment using customer relation management

(76) Inventors: Hwang-Sub Kwon, Seoul (KR); Joseph Kymm, Fullerton, CA (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 10/369,183

(22) Filed: Feb. 19, 2003

(30) Foreign Application Priority Data
Feb. 19, 2002 (KR) 2002-0008822

(51) Int. Cl. G06F 15/16

(52) U.S. Cl. 709/227

(57) ABSTRACT

A system for providing service in wireless network environment using customer relation management comprises: an operation server provided with integrated customer information database and customer preference database; and an access point connected to the operation server in server-client distribution environment and installed at a hot-spot, for recognizing a client wireless terminal that enters detection area; wherein the operation server comprises: a customer authentication module for determining whether the customer is registered to the customer information database using a device profile of the detected wireless terminal and a user identifier in response to a request of the access point; and a customer event analysis module for analyzing event information of the customer generated in the hot-spot and extracting customer preference information; the access point comprises: a recognition module for recognizing the client wireless terminal that enters the detection area, transferring a remote agent program and extracting the device profile of the wireless terminal and the user identifier. First customer information is analyzed in wireless network environment and the extracted customer preference information is actively provided to the customer using wireless terminals so that the customer can select products or services easily.

### BACKGROUND OF THE INVENTION

1. Field of the Invention

The present invention relates to a system and method for providing service in wireless network environment using customer relation management (CRM), and more particularly, to a system and method for providing service in wireless network environment using customer relation management, which recognizes that a customer registered in a hot-spot provided with an access point of a service provider enters and provides a favorite service based on customer preference information analyzed by CRM.

2. Description of the Related Art

The customer relation management (CRM) is a terminology to mean methodology or software used by an enterprise to manage customers relation, more particularly, customer oriented management technology in which information on present customers and potential customers is sorted and analyzed to be converted into marketing information and customer's purchase behavior is measured to develop, implement and modify a marketing program based on the measured customer's purchase behavior.

The type of CRM can be classified into strategy oriented CRM, database oriented CRM, analysis oriented CRM, interface management oriented CRM and personalization oriented CRM.

Among them, especially personalization oriented CRM is oriented on how products, service, compensation, etc. are discriminated for each customer. This helps to make the quality of the products, service, compensation, etc. provided to each customer beast and to expand the area of the customers who are provided with them through synergy.

However, according to the conventional personalization oriented CRM, the analyzed customer preference information could not be provided to each of the customers actively. Furthermore, it was difficult to solve this problem when the environment of communication infrastructure is changed from wire network environment to wireless network environment.

It is difficult to suggest a new solution to integrate, manage and analyze customer information database since the customer information database is very various and dispersed widely.

### SUMMARY OF THE INVENTION

Therefore, it is an object of the present invention to provide a system and method for providing service in wireless network environment using CRM, in which customer information is analyzed in wireless network environment and the extracted customer preference information is actively provided to the customer using wireless terminals.

It is other object of the present invention to provide a system and method for providing service in wireless network environment using CRM, in which widely dispersed customer information database is integrated, managed and analyzed to find customer preference information and the customer preference information is integrated and managed.

To achieve one of the aforementioned objects of the present invention, a system for providing service in wireless network environment using customer relation management comprises: an operation server provided with integrated customer information database and customer preference database; and an access point connected to the operation server in server-client distribution environment and installed at a hot-spot, for recognizing a client wireless terminal that enters detection area; wherein the operation server comprises: a customer authentication module for determining whether the customer is registered to the customer information database using a device profile of the detected wireless terminal and a user identifier in response to a request of the access point; and a customer event analysis module for analyzing event information of the customer generated in the hot-spot and extracting customer preference information; the access point comprises: a recognition module for recognizing the client wireless terminal that enters the detection area, transferring a remote agent program and extracting the device profile of the wireless terminal and the user identifier.

Preferably, the operation server further comprises: a database management module for comparing a personal identification number (PIN) transmitted from the access point an ID registered to a local customer information database with the device profile extracted by the remote agent program and distributing and storing user identifier.

Preferably, the access point further comprises: a payment module connected to a POS system in the hot-spot, for receiving payment information of the customer through the POS system and transmitting the payment information to the operation server so that the operation server analyzes the payment information of the customer and extracts the customer preference information to store the customer preference information on the customer preference database.

Furthermore, according to another aspect of the present invention, a method for providing service in wireless network environment using customer relation management, which is applied to a system providing service that includes an access point installed at a hot-spot and connected to a wireless terminal in a detection area through a local wireless network and an operation server connected to the access point through the network comprises the steps of: (a) detecting a client wireless terminal that enters the detection area of a hot-spot provided with the access point and transferring a remote agent program; (b) extracting the device profile of the wireless terminal and the user identifier from the transferred remote agent program and transferring the extracted device profile of the wireless terminal and the extracted user identifier to the access point; (c) transferring the transferred device profile of the wireless terminal and the transferred user identifier to the operation server and determining whether the wireless terminal belongs to the customer registered to an integrated customer information database; (d) if the wireless terminal belongs to the customer registered to an integrated customer information database, searching customer preference information database of the operation server for customer preference information corresponding to the hot-spot; and (e) providing a local service to the wireless terminal through the access point based on the searched customer preference information.

Preferably, the method further comprises the steps of: (f) receiving payment information of the customer through a POS system and transmitting the payment information to the operation server at the access point connected to the POS system in the hot-spot; and (g) analyzing payment information of the customer and extracting customer preference information to store the customer preference information on the customer preference database at the operation server.

Preferably, The method further comprises the steps of: (h) if the wireless terminal does not belong to the customer registered to the integrated customer information database of the operation server, determine whether the wireless terminal belongs to the customer registered to a local service of a service provider of the hot-spot; (i) if the wireless terminal belongs to the customer registered to the local service, receiving a personal identification number (PIN) and an ID registered on a local customer information database through the remote agent program and transmitting the PIN and the ID to the operation server at the access point; and (j) matching the device profile extracted by the remote agent program, endowing the customer with a user identifier and storing the user identifier on the integrated customer information database at the operation server.

### BRIEF DESCRIPTION OF THE DRAWINGS

The above objects and other advantages of the present invention will become more apparent by describing preferred embodiments thereof in detail with reference to the attached drawings in which:

FIG. 1 shows a configuration of the network of the system providing service according to the present invention;

FIG. 2 is a block diagram illustrating the network of the system providing service according to the present invention; and

FIG. 3 is a flowchart illustrating the service method applied to the system providing service according to the present invention.

### DETAILED DESCRIPTION OF THE PREFERRED EMBODIMENTS

Now, preferred embodiments of the present invention will be described in detail with reference to the annexed drawings.

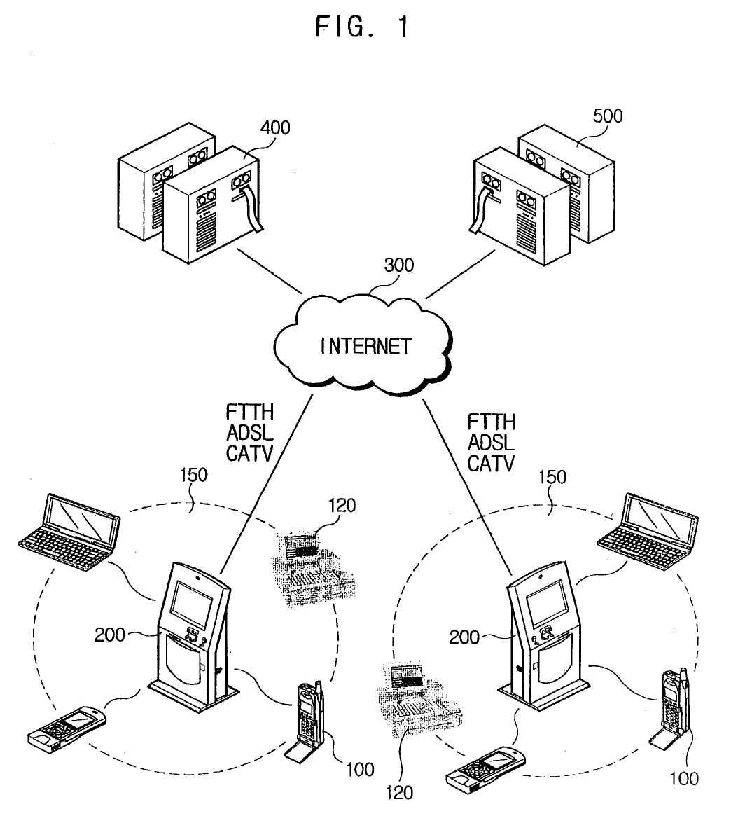

FIG. 1 shows a configuration of the network of the system providing service according to the present invention.

A client wireless terminal 100 includes a wireless communication module, for example, a mobile phone and can be applied to a PDA, a tablet PC, a CNS and a tablet PC installed at a hot-spot.

In addition, an access point 200 is installed at a hot-spot 150 congested by users such as a hotel, an airport, a bus terminal, conference hall, a restaurant, a hospital, a monetary facility and a department store.

The access point 200 is connected to a operation server 400 through a network 300 such as Internet in server-client distribution environment and can recognizes the client wireless terminal 100 that enters detection area of the hot-spot 150. The access point 200 is connected to the client wireless terminal 100 based on a broadband wireless LAN of the world standard (802.11b, 802.11a or 802.11g).

When the payment information required by the client wireless terminal 100 is transmitted to a monetary server 500 through a POS system 120 and payment is completed, the custom selection event based on the payment information is transferred to the operation server 400 and customer preference is analyzed.

The access point 200 makes Internet surfing possible and is a kind of a multifunctional kiosk that has a telephone function or a cash ejection function.

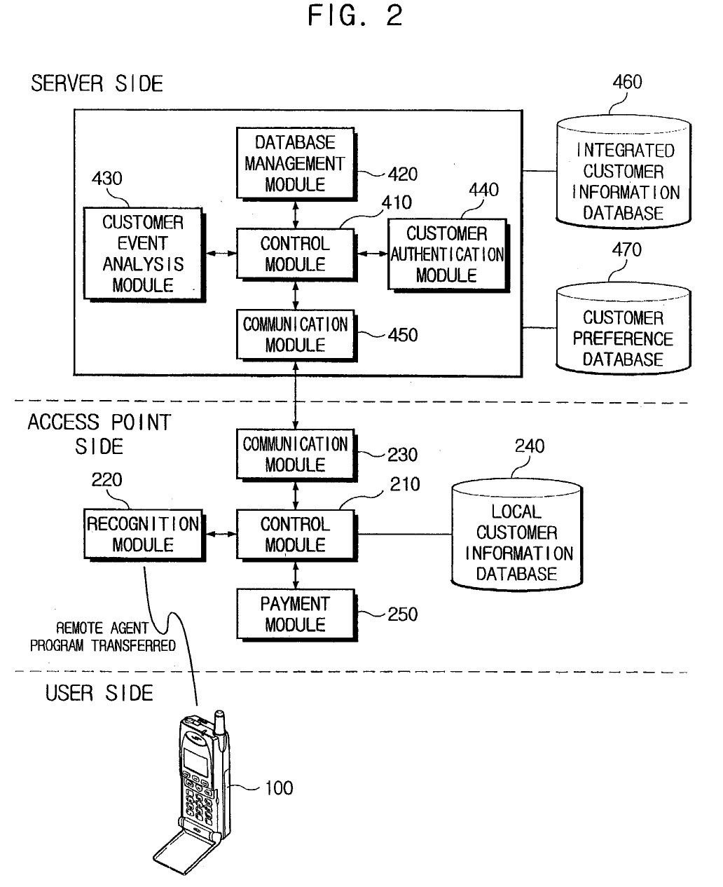

FIG. 2 is a block diagram illustrating the network of the system providing service according to the present invention.

A customer authentication module 440 of the operation server 400 performs an authentication procedure in which it is determined whether the customer is registered to integrated customer information database 460 based on a device profile of the wireless terminal 100 recognized by the request of the access point 200 and a user identifier (UID).

A customer event analysis module 430 receives customer event information generated in the hot-spot 150 from the access point 200, analyzes the customer event information and extracts customer preference information.

A database management module 420 stores the customer preference information analyzed by the customer event analysis module 430 on customer preference database 470, stores inputted customer information on integrated customer information database 460, matches local customer information that can be accessed by an access point 200 and stores the local customer information on the integrated customer information database 460 to manage it.

A communication module 450 transmits and receives data to and from the access point 200 through the network 300 such as Internet.

In addition, a control module 410 controls all modules to transfer the data received through the communication module 450 to a customer event analysis module 430, a customer authentication module 440 or a database management module 420 to process the data. The control module 410 stores the result data on database or transmits to the access point 200.

A recognition module 220 of the access point 200 transmits a remote agent program to the client wireless terminal 100 that enters a detection area of the hot-spot 150 and recognizes a device profile and a user identifier.

In addition, payment module 250 receives the payment information that is requested by the client wireless terminal 100 and processed by the POS system 120 and transfers to the operation server 400.

A control module 210 of the access point 200 transfers a device profile of the wireless terminal 100 and a user identifier that are received from a recognition module 220 through a communication module 230 to the operation server 400, and receives custom preference information from the operation server 400 to provides the custom preference information to the wireless terminal 100 or receives payment acknowledgement information from the monetary server to provides the payment acknowledgement information to the wireless terminal 100 through a payment module 250.

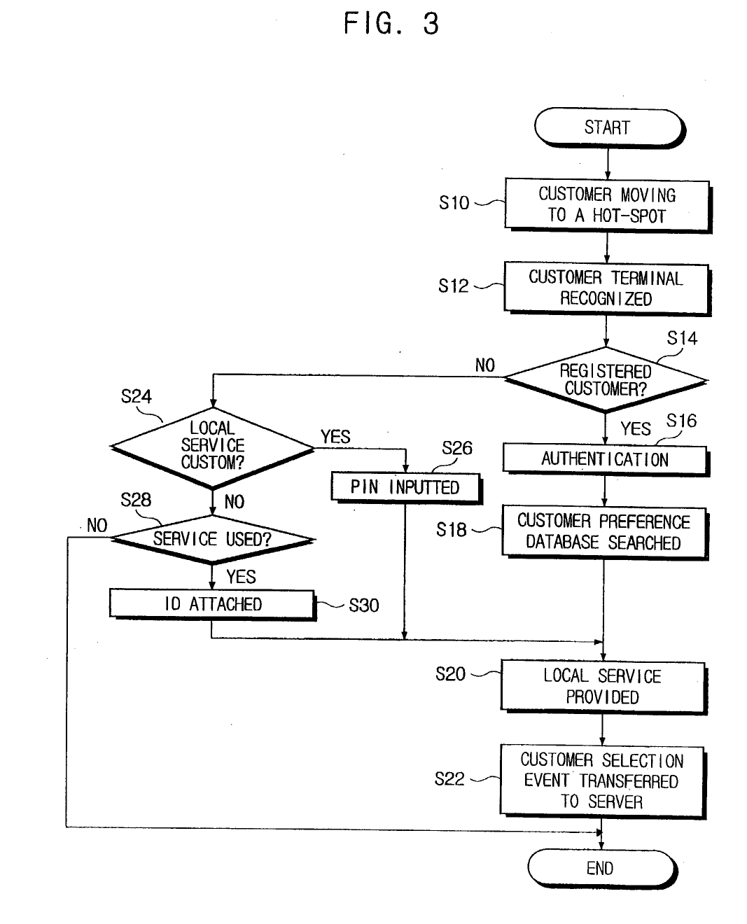

FIG. 3 is a flowchart illustrating the service method applied to the system providing service according to the present invention. For convenience in description, it is supposed that a customer who has a mobile phone as a wireless terminal orders dishes in a restaurant.

The customer with a mobile phone 100 enters a restaurant 150 in which the access point 200 is installed (step S10) and comes in a detection area. The recognition module 220 of the access point 200 detects the customer's coming and transfers a remote agent program to the mobile phone 100 wirelessly to perform recognition procedure (step S12).

The access point 200 and the wireless terminal 100 can communicate with each other by means of local area wireless network such as a Bluetooth wireless system, a wireless LAN, etc.

The remote agent program transmitted to the wireless terminal 100 is constituted by Java language and recognizes a device profile and a user identifier from the wireless terminal 100.

The recognized device profile and user identifier is transmitted to the recognition module 220 of the access point 200 and this information is transferred to the operation server 400 via the communication module 230 under the control of the control module 210.

A customer authentication module 440 of the operation server 400 ascertains whether the customer has been registered to the integrated customer information database 460 using the transferred device profile and the user identifier (step S14).

If the customer has been registered to the integrated customer information database 460, the customer event analysis module 430 searches customer preference information database for customer preference information according to the type of the hot-spot 150 based on the customer information (step S18).

Subsequently, the local service corresponding to the hot-spot is provided (step S20).

In other words, since the customer preference information on which dishes are the favorite dishes of the customer has been stored on the customer preference database 470 based on order events at the restaurant in which the access point 200 is installed, the customer event analysis module 430 provides a local service corresponding to the restaurant based on such a preference information. For example, in a Korean food restaurant, if the searched customer preference information says that the customer likes the following foods in order of preference, “Gimchijjige”, “Cheonggukjang” and “Donkass”, then the access point 200 transmits a message such as “Your favorite dish is Gimchijjige in this restaurant, isn't it?” to the wireless terminal 100 based on such customer preference information.

A service is provided based on the customer preference information of the area the customer visits so that it is helpful for the customer to get information.

Meanwhile, the payment for the service selected by the customer in the hot-spot 150 is performed by means of the POS system 120 connected to wireless network. The payment of the POS system 120 is acknowledged by the monetary server 500. At this time, the payment module 250 of the access point 200 receives payment information from the POS system 120 and sends it to the operation server 400 (step S22).

A customer event analysis module 430 of the operation server 400 extracts the customer preference information from the transferred payment information and stores it on the customer preference database 470.

On the other hand, if the customer has not been registered to the integrated customer information database 460, it is determined whether the customer has been registered to a local service of a service provider of the hot-spot 150 (step S24). In other words, it can happen that the customer has not been registered to the integrated customer information database 460 but the customer has been registered to local customer information database 240 constructed by a service provider of the hot-spot 150.

If the customer has been registered to the local customer information database 240, a personal identification number (PIN) and an ID are inputted in response to the message provided by the remote agent program (step S26). Here, the ID is the ID registered to the local customer information database 240.

Then, the customer can use the local service and the inputted PIN and ID are transmitted to the operation server 400 and stored on the integrated customer information database 460. The inputted PIN and ID match a device profile extracted by the remote agent program and a user identifier is attached. They are stored on the integrated customer information database. After that, the wireless terminal is recognized by means of the device profile and the user identifier.

If the customer has not been registered to the local customer information database 240 at step S26, the remote agent program ascertains whether the service according to the present invention will be provided (step S28).

If the service according to the present invention will be used, a user identifier is inputted (step S30) and the local service is provided. If the service according to the present invention will not be used, it is terminated.

While the present invention has been described in detail, it should be understood that various changes, substitutions and alterations can be made hereto without departing from the spirit and scope of the invention as defined by the appended claims.

According to the present invention, a service based on the customer preference information is provided based on personalization oriented CRM and various contents can be provided additionally.

For example, when a customer visits a cinema which is a hot-spot with an access point, the favorite kind of movies are provided. basically but information related to the areas around the cinema can be provided additionally.

As described above, the present invention has various advantages.

First, customer information is analyzed in wireless network environment and the extracted customer preference information is actively provided to the customer using wireless terminals so that the customer can select products or services easily.

Furthermore, widely dispersed customer information database is integrated, managed and analyzed to find customer preference information and the customer preference information is integrated and managed so that the same services are provided to the customer even though the customer approaches any area in which an access point is installed.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for providing service in wireless network environment using customer relation management, the system comprising:
an operation server provided with integrated customer information database and customer preference database; and
an access point connected to the operation server in server-client distribution environment and installed at a hot-spot, for recognizing a client wireless terminal that enters detection area;
wherein the operation server comprises:
a customer authentication module for determining whether the customer is registered to the customer information database using a device profile of the detected wireless terminal and a user identifier in response to a request of the access point; and
a customer event analysis module for analyzing event information of the customer generated in the hot-spot and extracting customer preference information;
the access point comprises:
a recognition module for recognizing the client wireless terminal that enters the detection area, transferring a remote agent program and extracting the device profile of the wireless terminal and the user identifier.

2. The system according to claim 1, wherein the operation server further comprises:
a database management module for comparing a personal identification number (PIN) transmitted from the access point an ID registered to a local customer information database with the device profile extracted by the remote agent program and distributing and storing user identifier.

3. The system according to claim 1, wherein the access point further comprises:
a payment module connected to a POS system in the hot-spot, for receiving payment information of the customer through the POS system and transmitting the payment information to the operation server so that the operation server analyzes the payment information of the customer and extracts the customer preference information to store the customer preference information on the customer preference database.

4. A method for providing service in wireless network environment using customer relation management, which is applied to a system providing service that includes an access point installed at a hot-spot and connected to a wireless terminal in a detection area through a local wireless network and an operation server connected to the access point through the network, the method comprising the steps of:
(a) detecting a client wireless terminal that enters the detection area of a hot-spot provided with the access point and transferring a remote agent program;
(b) extracting the device profile of the wireless terminal and the user identifier from the transferred remote agent program and transferring the extracted device profile of the wireless terminal and the extracted user identifier to the access point;
(c) transferring the transferred device profile of the wireless terminal and the transferred user identifier to the operation server and determining whether the wireless terminal belongs to the customer registered to an integrated customer information database;
(d) if the wireless terminal belongs to the customer registered to an integrated customer information database, searching customer preference information database of the operation server for customer preference information corresponding to the hot-spot; and
(e) providing a local service to the wireless terminal through the access point based on the searched customer preference information.

5. The method according to claim 4, further comprising the steps of:
(f) receiving payment information of the customer through a POS system and transmitting the payment information to the operation server at the access point connected to the POS system in the hot-spot; and
(g) analyzing payment information of the customer and extracting customer preference information to store the customer preference information on the customer preference database at the operation server.

6. The method according to claim 4, further comprising the steps of:
(h) if the wireless terminal does not belong to the customer registered to the integrated customer information database of the operation server, determine whether the wireless terminal belongs to the customer registered to a local service of a service provider of the hot-spot;
(i) if the wireless terminal belongs to the customer registered to the local service, receiving a personal identification number (PIN) and an ID registered on a local customer information database through the remote agent program and transmitting the PIN and the ID to the operation server at the access point; and
(j) matching the device profile extracted by the remote agent program, attaching a user identifier and storing the user identifier on the integrated customer information database at the operation server.
